(19) United States
(12) Patent Application Publication
(10) Pub. No.: US 2004/0247960 A1
(43) Pub. Date: Dec. 9, 2004

(54) Fuel cell system

(75) Inventors: Yuusuke Sato, Tokyo (JP); Kaoru Fujimoto, Kitakyuushuu-shi (JP); Kenji Asami, Kitakyuushuu-shi (JP); Yoshiyuki Isozaki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/810,715

(22) Filed: Mar. 29, 2004

(30) Foreign Application Priority Data
Mar. 31, 2003 (JP) P2003-96427
Mar. 31, 2003 (JP) P2003-96436

(51) Int. Cl. H01M 8/06; C10L 1/12

(52) U.S. Cl. 429/20; 429/34; 44/457

(57) ABSTRACT

A fuel cell system includes a fuel tank storing a fuel comprising an ether, water, and an alcohol; a vaporizer vaporizing the fuel; a reformer reforming the vaporized fuel into a hydrogen rich gas; a CO gas removal apparatus configured to remove CO gas in the hydrogen rich gas; and a fuel cell unit configured to generate electricity by electrochemical reaction of the hydrogen rich gas and oxygen.

### CROSS REFERENCE TO RELATED APPLICATIONS

This application is based upon and claims the benefit of priority from the prior Japanese Patent Applications No. P2003-096427 and P2003-096436, filed on Mar. 31, 2003; the entire contents of which are incorporated herein by reference.

### BACKGROUND OF THE INVENTION

1. Field of the Invention

The present invention relates to a fuel cell system, which reforms a fuel into a hydrogen rich gas and generates electricity by allowing the hydrogen rich gas to react with oxygen.

2. Description of the Related Art

Fuel cells are classified as a polymer electrolyte fuel cell, a phosphoric-acid fuel cell, an alkaline fuel cell, a molten carbonate fuel cell, a solid oxide fuel cell and the like, depending on the kinds of electrolytes to be used. Hydrogen, to be supplied to the fuel cell unit, can be provided by fuels which are reformed into hydrogen rich gas in a reformer, instead of being provided by the gas cylinder. As to the fuels, natural gas, propane gas, methanol and the like can be used. Water, to reform fuels into hydrogen rich gas, and fuels are supplied to the reformer separately and hydrogen rich gas is produced by use of a catalyst.

However, a recent fuel cell system does not necessarily show high catalytic activities for reforming fuels into hydrogen gas. Therefore, the size of the reformer is enlarged so as to supply the proper necessary amount of hydrogen to generate electricity. Since the reformer is enlarged, the entire system of the fuel cell system is also enlarged.

In addition, in such a fuel cell system, pumps which supply fuels and water to be utilized for a reforming reaction are required. Therefore the space for the pump is required. Since the power for driving the pump may be provided by the electricity generated by the fuel cell, the total efficiency of generating electricity by the fuel cell may be decreased.

The present invention was made for solving the foregoing problems. An object of the present invention is to provide a fuel cell system having a high efficiency for reforming fuel to hydrogen rich gas and a high efficiency for generating electricity with a small and simple structure.

### SUMMARY OF THE INVENTION

An aspect of the present invention inheres in a fuel cell system comprising a fuel tank storing a fuel comprising an ether, water, and an alcohol; a vaporizer vaporizing the fuel; a reformer reforming the vaporized fuel and water into a hydrogen rich gas; a CO gas removal apparatus configured to remove or reduce CO gas in the hydrogen rich gas; and a fuel cell unit configured to generate electricity by electrochemical reaction of the hydrogen rich gas and oxygen.

Another aspect of the present invention inheres in a fuel cell system encompassing a first fuel tank storing a first fuel including ether; a second fuel tank storing a second fuel including a methanol and water; a vaporizer vaporizing the second fuel; a reformer reforming the first and second fuel into a hydrogen rich gas; a CO gas removal apparatus configured to remove or reduce CO gas from the hydrogen rich gas; and a fuel cell unit configured to generate electricity by electrochemical reaction of the hydrogen rich gas and oxygen.

Still another aspect of the present invention inheres in a fuel cell system encompassing a first tank storing a fuel including ether; a second tank storing water; a third tank storing a hydrogen; a vaporizer vaporizing the water; a reformer configured to introduce the fuel, water, and hydrogen to reform the fuel into a hydrogen rich gas; a CO gas removal apparatus configured to remove or reduce CO gas from the hydrogen rich gas; and a fuel cell unit configured to generate electricity by electrochemical reaction of the hydrogen rich gas and oxygen.

Still another aspect of the present invention inheres in a fuel for a fuel cell system encompassing dimethyl ether; water; and 5-10 wt % of methanol, wherein the mixing ratio of dimethyl ether and water is in a range of 1:3 to 1:4.

Still another aspect of the present invention inheres in a fuel tank for a fuel cell system comprising dimethyl ether, water, and methanol.

### BRIEF DESCRIPTION OF DRAWINGS

FIG. 1 is a block diagram showing an example of a fuel cell system according to a first embodiment of the present invention.

FIG. 2 is a sectional view of a fuel tank according to the first embodiment according to the present invention.

FIG. 3 is a block diagram of a first modification of the first embodiment according to the present invention.

FIG. 4 is a block diagram of a second modification of the first embodiment according to the present invention.

FIG. 5 is a block diagram showing an example of a fuel cell system according to a second embodiment of the present invention.

FIG. 6 is a block diagram of amodification of the second embodiment according to the present invention.

FIG. 7 is a block diagram showing an example of a fuel cell system according to a third embodiment of the present invention.

FIG. 8 is a block diagram of a first modification of the third embodiment according to the present invention.

FIG. 9 is a block diagram of a second modification of the third embodiment according to the present invention.

FIG. 10 is a block diagram of a third modification of the third embodiment according to the present invention.

FIG. 11 is a block diagram showing an example of a fuel cell system according to a fourth embodiment of the present invention.

FIG. 12 is a block diagram of a modification of the fourth embodiment according to the present invention.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and description of the same or similar parts and elements will be omitted or simplified. However, it will be obvious to those skilled in the art that the present invention may be practiced without such specific details.

(First Embodiment)

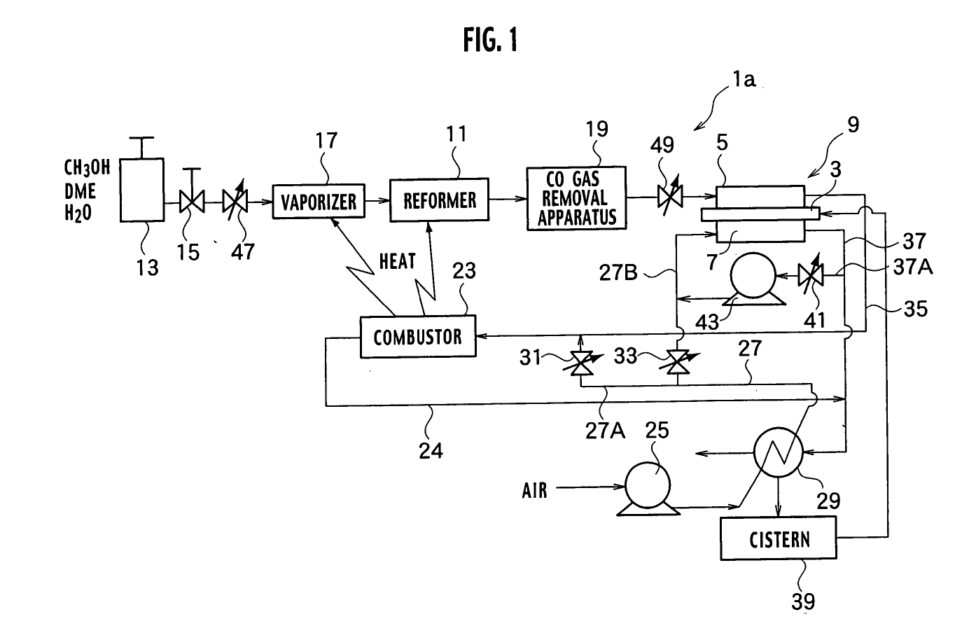

As shown in FIG. 1, a fuel cell system 1a according to a first embodiment of the present invention includes a fuel tank (first fuel tank) 13 configured to store a fuel comprising an ether, water, and an alcohol, a vaporizer 17 configured to vaporize the fuel, a reformer 11 configured to reform the vaporized fuel into a hydrogen rich gas, a CO gas removal apparatus 19 configured to remove or reduce CO gas in the hydrogen rich gas, and a fuel cell unit 9 configured to generate electricity by electrochemical reaction of the hydrogen rich gas and oxygen.

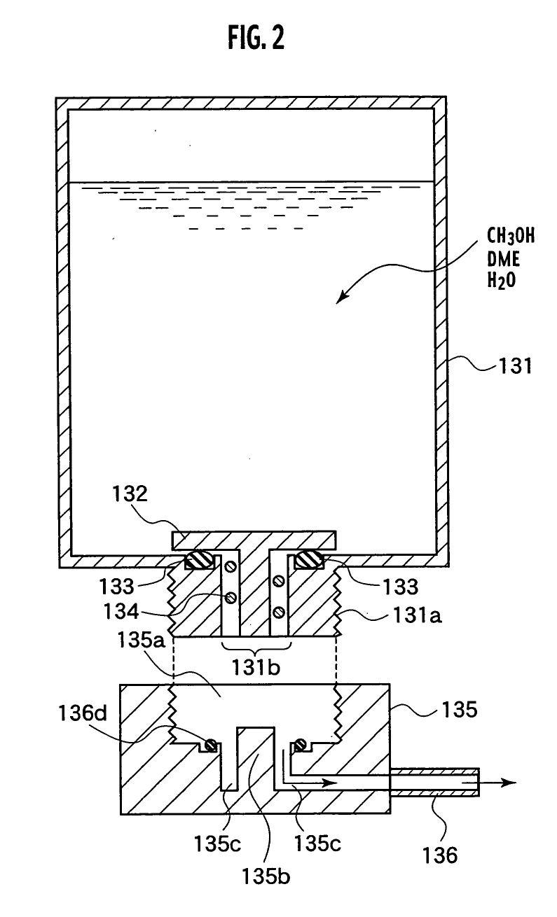

The first fuel tank 13 is a container which can store fuel including liquid and gas. As shown in FIG. 2, the first fuel tank 13 has a cartridge unit 131 configured to store the fuel and a holding unit 135 configured to hold the cartridge unit 135 opposite to the cartridge unit 131. A projection 131a protruding from the cartridge unit 131 is disposed in one end of the cartridge unit 131. The projection 131a has a thread on an outside wall of the projection 131a to connect with the holding unit 135. An opening 131b configured to release the fuels from the cartridge unit 131 is disposed at a center of the projection 131a. A valve element 132 having a “T” shape is inserted in the opening 131b from inside of the first fuel tank 13. One end of a spring 134 is fixed to the valve element The other end of the spring 134 is fixed on an inner wall of the projection 131a. On the inner wall of the fuel tank 13, a first O-ring 133 is disposed in a small recess at the inner wall of the projection 131a. Since the valve element 132 is pressured by the fuel and pulled by the tension of the spring 134 to the o-ring 133, fuels stored in the cartridge unit 131 are prevented from leaking outside.

The holding unit 135 has a recess 135a for inserting the projection 131a so as to fix the cartridge unit 131. A thread to connect with the projection 131a is formed at an inner wall of the recess 135a. A valve push unit 135b protrudes from a center of the bottom surface of the recess 135a. A producing unit 135c to release fuels from the cartridge unit 131 is disposed around the valve push unit 135b. A second O-ring 136d is disposed in a small recess formed in the bottom surface of the recess 135a. The cartridge unit 131 is fixed to the holding unit 135 and adhered to each other sealed by the second O-ring 136d. When the cartridge unit 131 and the holding unit 135 are adhered or connected by the second O-ring 136d, the valve push unit 135c pushes the end of the valve element 132 upward. As a result, fuels stored in the cartridge unit 131 are introduced to the introducing unit 135c or passage. Fuels are introduced to the supplying unit 136 which is connected to the introducing unit 135c or passage.

In the fuel tank 13, a liquid fuel containing ether, water, and alcohol may be stored. As to the fuels, for example, a solution containing about 5% of methanol (CH₃OH) by weight to a solution of dimethyl ether (DME) and water (H₂O) at a mole ratio of about 1:4 may be provided. As shown in the following balanced chemical equation (1), DME reacts with water at a mole ratio of 1:3 in a stoichiometric chemical reaction, andgenerates hydrogen (H₂) andcarbondioxide (CO).

CH₃OCH₃+3H₂O→6H₂+2CO₂ (1)

In order to achieve a high efficiency of hydrogen generation, the amount of the water mixed with DME is desirable to be around H₂O:DME=1:3 at a stoichiometric mole ratio. Further, in order to reform DME completely, the stoichiometric ratio of water to DME may be determined to be greater than 3. Therefore, it is desirable that the mixing ratio of DME and water may be determined around in a range of 1:3 to 1:4 at a mole ratio. However, DME dissolves only around 1:7 mole ratio at room temperature (25° C.). Therefore, methanol which has a greater affinity for both DME and water is added to make DME and water dissolve at a mole ratio of 1:4. The amount of methanol which may be added is less than about 10 wt %, more likely in a range of 5-10 wt %. When the amount of methanol in the fuel is decreased less than 5 wt %, DME and water may be separated into two phases. The desirable ratio of the fuel to reform DME into hydrogen is about less than 10 wt % of methanol, more likely in a range of 5-10 wt %.

As is well known, the vapor pressure of DME at room temperature (25° C.) is about 6 atm, which is higher than atmospheric pressure. When the mixed solution of DME, water, and methanol is stored as fuel in the first fuel tank 13 at room temperature, the vapor pressure occurring in the first fuel tank 13 depends on the composition of the fuel. A vapor pressure of about 4 atm may occur in the first fuel tank 13 in case of 5 wt % methanol to 1:4 mole ratio of DME and water.

As shown in FIG. 1, a variable conductance valve 15 which can adjust a flow rate is coupled to the downstream side of the first fuel tank 13 via a pipe. A mass flow control valve 47 is coupled to a pipe coupled to the downstream side of the variable conductance valve 15. A pipe coupled to the mass flow control valve 47 is coupled to a vaporizer 17. When the variable conductance valve 15 and the mass flow control valve 47 are opened, fuel mixture solution stored in the first fuel tank 13 is actively supplied to the vaporizer 17 by the vapor pressure occurring in the first fuel tank 13. Thus, a pump to supply fuel can be omitted and the entire system is minimized, and therefore power required for the pump is omitted. Since the fuel mixture solution contained in the fist fuel tank 13 is provided in a state of liquid, the mixture ratio of the fuel can be maintained in a proper condition.

The vaporizer 17 vaporizes the liquid fuel by heating. The vaporizer 17 is heated to about 150-250° C. by a heater provided outside of the system or a combustor 23 which is described later. In addition, the vaporizer 17 is pressurized to a pressure higher than atmospheric pressure by the pressure occurring in the fist fuel tank 13. The vaporized fuel in the vaporizer 17 is supplied to the reformer 11 via a pipe.

The reformer 11 is configured to allow fuels and water vaporized in the vaporizer 11 to react and to reform the fuels into a hydrogen rich gas. The reformer 11 is heated to about 300-400° C., or likely to about 350° C. by the heater provided outside of the system (not shown) or the combustor 23. A “reforming catalyst” and a “shift catalyst” may be provided in the reformer 11. The “reforming catalyst” prompts a reforming reaction of the fuel. The “shift catalyst” prompts a shift reaction which produces H₂ and CO₂ from CO and H₂O. As to the reforming catalyst and the shift catalyst, a catalyst comprising alumina (Al₂O₃) and a metal selected from a group of rhodium (Rh), palladium (Pd), platinum (Pt), and copper (Cu) may be utilized. In the reformer 11 as shown in FIG. 1, a catalyst comprising alumina (γ-almina) and Rh is used. In addition, a catalyst comprising γ-almina and Cu/Zn may be provided as a shift catalyst.

In the reformer 11, the following reactions as shown in balanced chemical equation (2), (3) and (4) occur;

CH₃OCH₃+H₂O→2CH₃OH (2)

CH₃OH→2H₂+CO (3)

CO+2H₂O→2H₂+CO₂ (4)

Here, equations (2) and (3) are called a “reforming reaction”. Equation (4) is called a “shifting reaction”.

In general, a hydrolysis reaction of DME as shown in equation (2) reacts slower than the reactions as shown in equations (3) and (4) When methanol, which is a hydrolyzate from the hydrolysis reaction of DME, is decomposed, the hydrolysis reaction of DME as shown in equation (2) is prompted. Since hydrogen is contained in the product gas, the hydrogen atom is adsorbed to the surface of the catalyst and the hydrogen atom adsorbed on the catalyst prompts the hydrolysis reaction of DME as shown in equation (2).

Since the fuel includes methanol, decomposing reaction of equation (3) which reacts faster than reaction of equation (2) occurs and hydrogen is produced. The hydrogen prompts the efficient reforming reaction of DME as shown in reaction (2), for improving conversion of DME into hydrogen rich gas. Thus, the simple structure fuel cell system 1a as shown in FIG. 1 can achieve high efficiency in the reforming reaction of DME into a hydrogen rich gas.

In addition, since the reforming catalyst and the shift catalyst are mixed and provided in the same container, the reforming reaction and shifting reaction proceeds at the same time. In other words, when the shift reaction of equation (4) occurs, CO is reacted and removed. When the concentration of CO is decreased in the reformer 11, the decomposing methanol reaction of equation (3) is promoted. When decomposing methanol reaction is promoted in the reformer 11, the hydrolysis reaction of DME of equation (2) is also promoted. As a result, a effective reforming reaction of DME occurs. Therefore, the fuel cell system 1a as shown in FIG. 1 can achieve high efficiency of reforming fuels into hydrogen rich gas. Further, since the reforming catalyst and shift catalyst are provided in the same container, it is possible to minimize the size of the fuel cell system 1a.

As shown in reaction (3), a small amount of CO gas is included in the reformed gas in the reformer 11. To remove or reduce CO gas, the CO gas removal apparatus 19 is coupled to the downstream side of the reformer 11. In the CO gas removal apparatus, a “selective methanation reaction” as shown in the following chemical equation occurs:

CO+3H₂→CH₄+H₂O (5)

Here, CO in the gas is reduced to less than 10 ppm at mole concentration. A methanation catalyst for urging reaction of CO with H₂ to produce CH₄ and H₂O, without reacting CO₂ and H₂ so much may be provided in the CO gas removal apparatus 19. As the methanation catalyst, ruthenium (Ru) may be utilized. It is desirable that the CO gas removal apparatus 19 is pressurized by use of a back ressure regulating valve 49 which is connected to the downstream side of the CO gas removal apparatus 19. The upstream side of the back pressure regulating valve 49 may be pressurized to about 3 atm. Consequently, when the CO gas removal apparatus 19 is pressurized, reforming and methanation reactions is performed more efficiently as compared to the case where these reactions performed at atmospheric pressure.

Another way of removing CO gas may be performed by the following reaction:

CO+1/2O₂→CO₂ (6)

In the reaction of equation (6), when oxygen is supplied to the CO gas removal apparatus 19, the CO gas can be oxidized and removed selectively. In this event, a partial oxidation catalyst such as ruthenium (Ru) may be utilized in the CO gas removal apparatus 19. The catalyst such as Ru can promotes to react CO with oxygen, without reacting hydrogen with oxygen not much.

On the downstream side of the back pressure regulating valve 49, a fuel cell unit 9 is coupled. As the fuel cell unit 9, a proton exchange membrane fuel cell (PEMFC) may be utilized. The fuel cell unit 9 includes a fuel electrode (anode) 5, an air electrode (cathode) 7 opposite the fuel electrode 5, and a polymer electrolyte membrane (ion-exchange membrane) 3 permitting ion conductivity interposed between the fuel electrode 5 and the air electrode 7. A pipe coupled to the back pressure regulating valve 49 is coupled to the upstream side of the fuel electrode 5. The hydrogen rich gas is introduced to the fuel electrode 5 via the pipe. In the fuel electrode 5, hydrogen is dissociated into hydrogen ions and electrons near an anode catalyst provided in the fuel electrode 5. The dissociated electrons pass through the cathode (an air electrode) 7 via an outer circuit. The dissociated hydrogen ions pass through the polymer electrolyte membrane 3 and move to the air electrode 7. Consequently, in the air electrode 7, the hydrogen ions react with oxygen and electrons passed through the outer circuit and generate water. In such way, electricity is generated.

In the fuel electrode 5 of the fuel cell unit 9, a gas including hydrogen is provided. The gas including hydrogen is introduced to the combustor 23 via the pipe 35. Air to burn the gas is supplied from the first pump 25 via a heat exchanger 29 coupled to the first pump 25, a pipe 27 coupled to the heat exchanger 29, a mass flow control valve 33 coupled to the pipe 27 and apipe 27B coupled to the pipe on the upstream side of the air electrode 5.

The combustor 23 is a catalytic combustor to combust the gas introduced from the fuel electrode 5 via the pipe 35 with a catalyst. The combustor 23 may be heated to around 300-400° C. The heat generated by catalytic combustion may be transmitted to the vaporizer 17 and reformer 11 and used as heat for the evaporation and the chemical reactions. The burned gas is supplied to the pipe 24 which is coupled to the downstream side of the combustor 23 and heat exchanger 29 coupled to the pipe 24. In the heat exchanger 29, the gas is cooled and water is generated. Water generated in the heat exchanger 29 is stored in a cistern 39 which is connected to the heat exchanger 29. Water stored in the cistern 39 may be supplied to the polymer electrolyte membrane 3 via pipe connected between the cistern 39 and the polymer electrode membrane 3. Thus the moisture retention property of the polymer electrode membrane 3 can be maintained in a suitable condition.

Air to supply the air electrode 7 is pressurized by the first pump 25. The air goes through the heat exchanger 29 coupledto the firstpump 25, thepipe 27, themass flow control valve 33, and the pipe 27B to the air electrode 7. A part of the discharged gas discharged from the air electrode 7 is supplied to the heat exchanger 29 via the pipe 37 coupled to the downstream side of the air electrode 7. The discharged gas is cooled in the heat exchanger 29. On the downstream side of the air electrode 7, a pipe 37 has a branched pipe 37A branched from the middle of the pipe 37 to circulate a part of the discharged gas which includes hydrogen and oxygen. On the downstream of the branched pipe 37A is coupled to a mass flow control valve 41. The mass flow control valve 41 is coupled to a second pump 43 coupled to the upstream side of the air electrode 7 via the pipe 27B.

In the fuel cell system 1a according to the first embodiment of the present invention, fuel including DME, water, and methanol is stored in the first fuel tank 13. In general, ether dissolves water at a mole ratio of 1:7 in room temperature. However, methanol makes ether dissolve with water at a mole ratio of about 1:4. Therefore, the desirable stoichiometric ratio for reforming fuel can be obtained. Consequently, since only the minimum amount of water used for reforming reaction can be stored in the first fuel tank 13, volume of the fuel mixture solution can be minimized. Moreover, since evaporation heat required for vaporizing water can also be saved with a required quantity, reforming efficiency of the fuel cell system 1a is improved. Since the heating area of the vaporizer 17 is minimized, the entire size of the vaporizer 17 can be minimized.

Moreover, the fuel cell system 1a as shown in FIG. 1 can provide the reforming catalyst and shift catalyst in the same container of the reformer 11. Therefore, the reforming reaction as shown in equations (2) and (3) and shifting reaction as shown in equation (4) is conducted at the same time. Thus, it is possible to minimize the entire system of the fuel cell system 1a as compared to a system where the catalysts are provided separately.

Furthermore, a part of the gas discharged from the air electrode 7 is pumped by the second pump 43 and supplied to the air electrode 7. When moisture retention property of the polymer electrolyte membrane 3 is decreased, film resistance of the polymer electrolyte membrane 3 is increased while allowing proton from the fuel electrode 5 to the air electrode 7. Since the part of the gas discharged from the air electrode 7 is circulated and supplied to the air electrode, the moisture retention property of the polymer electrolyte membrane 3 may be maintained in a suitable condition.

Furthermore, a part of the water accompanied by the gas which is not introduced to the air electrode 7 is also supplied to the polymer electrolyte membrane 3 after being condensed to water by the heat exchanger 39. Thus, the moisture retention property of the polymer electrolyte membrane 3 can be maintained in a suitable condition.

Since the vapor pressure of the fuel in the first fuel tank 13 occurs on the vaporizer 17, the reformer 11, the CO gas removal apparatus 19 and the fuel cell unit 9, respectively, a pump to supply fuel can be omitted. Therefore, power that would be required for a pump is not necessary and the entire fuel cell system 1a can be miniaturized and simplified. The power to supply to the pump is also omitted. In addition, the reforming reaction occur in the reformer 11 is performed pressure higher than atmospheric pressure by the vapor pressure, it is possible to minimize the size of the reformer 11 as compared to a system where the reforming reactions are performed in the atmospheric pressure.

Next, with reference to FIG. 1, description will be given of a method for using the fuel cell system 1a according to the first embodiment of the present invention.

First, to properly regulating flow, the variable conductance valve 15 and the mass flow control valve 47 are opened. When the variable conductance valve 15 and the mass flow control valve 47 are opened, liquid fuel is actively supplied to the vaporizer 17 by the vapor pressure occurs in the first fuel tank 13. Next, the liquid fuel is heated and vaporized in the vaporizer 17 which is heated to a range of about 150-250° C. The vaporized fuel is introduced into the reformer 11 via the pipe coupled to the vaporizer 17.

Next, the reformer 11 reforms the vaporized fuel to hydrogen rich gas. The reformer 11 is heated to a range of 300-400° C. In the reformer 11, reforming reaction of DME and decomposition reaction of methanol shown in equations (2) and (3) and the shifting reaction shown in equation (4) occur. Thus, hydrogen rich gas is produced. Hydrogen rich gas is introduced into the CO gas removal apparatus 19 via the pipe coupled to the reformer 11.

Next, the CO gas removal apparatus 19 reduces CO gas in the hydrogen rich gas to less than 10 ppm in a mole concentration. In the CO gas removal apparatus 19, reaction equation (5) or (6) occur. In this event, the reactions occur in the CO gas removal apparatus 19 and the reformer 11 will be improved by pressurizing with the back pressure regulating valve 49 at about 3 atm. Meanwhile, gases such as CO, CO₂, H₂ and H₂O are supplied into the fuel electrode 5 by adjusting flow rate of the back pressure regulating valve 49.

Next, the cell unit 9 generates electricity by allowing the hydrogen supplied to the fuel electrode 5 to react with the oxygen supplied to the air electrode 7. The oxygen is supplied to the air electrode 7 by pressurizing air from the first pump 25 via the heat exchanger 17, the pipe 27, the conductance control valve 33, and the pipe 27B. A part of the gas discharged from the air electrode 7 is introduced to the heat exchanger 29 via the pipe 37 and cooled in the heat exchanger 29. Water condensed from the gas in the heat exchanger 29 is stored in the cistern 39. The water is provided to the polymer electrolyte membrane 3 via the pipe connected to the cistern 39. Meanwhile, another part of the gas discharged from the air electrode 7 is supplied to the branched pipe 37A via the pipe 37. The gas supplied to the branched pipe 37A is pumped by the second pump 43 and introduced to the air electrode 7 again.

Next, the gas including surplus hydrogen discharged from the fuel electrode 5 is mixed with the air supplied from the first pump 25 via the heat exchanger 29, the pipes 27 and 27A, the mass flow control valve 31 and the pipe connected to the pipe 35. Thereafter, the mixture is supplied to the combustor 23. The surplus hydrogen gas is burned catalytically in the combustor 23. In this event, the heat generated in the combustor 23 is transferred to the vaporizer 17 and the reformer 11 and is utilized as energy for vaporization of fuel, reaction energy for reforming and heating. Subsequently, the combustion gas discharged from the combustor 23 is introduced into the pipe 24 and introduced into the heat exchanger 29. The gas is cooled and condensed by the heat exchanger 29. Water condensed from the gas in the heat exchanger 29 is stored in the cistern 39 and supplied to the polymer film 3.

(First Modification of the First Embodiment)

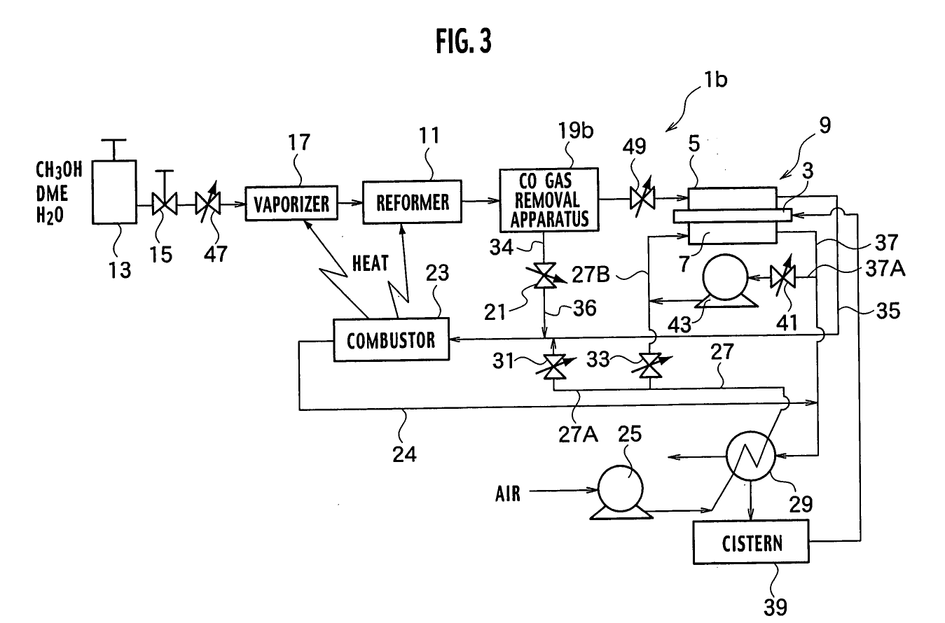

As shown in FIG. 3, in a fuel cell system 1b according to the first modification of the first embodiment includes a pipe 34 coupled to the downstream side of a CO gas removal apparatus 19b, back pressure regulating valve 21 coupled to the downstream side of the pipe 34, and a pipe 36 coupled to the downstream side of the back pressure regulating valve 21. The downstream side of the pipe 36 is coupled to the pipe 35. Points other than the above are substantially the same as those of the constitution shown in FIG. 1, and thus, description will be omitted.

The CO gas removal apparatus 19b selectively passes hydrogen from the hydrogen rich gas supplied from the reformer 11. Therefore, the gas which contains substantially hydrogen is supplied to the fuel electrode 5. The other gas which is not passed through the semipermeable membrane is supplied to the combustor 23 via pipe 34, back pressure regulating valve 21, the pipe 35 and 36. A semipermeable membrane, which selectively filters out substantially only hydrogen, is located inside of the CO gas removal apparatus 19b. As for the semipermeable membrane, for example, a silica containing semipermeable membrane may be used. The silica containing semipermeable membrane is obtained by depositing a silica film having a thickness of about 0.2 μm on a deposited γ-Al₂O₃ film having a thickness of about 0.6 μm on an α-Al₂O₃ board having a thickness of about 350 μm. In such a manner, when the semipermeable membrane is installed in the CO gas removal apparatus 19b, the internal temperature thereof may be maintained at about 250-350° C. The CO gas removal apparatus 14 is maintained at a pressure higher than atmospheric pressure by the vapor pressure occurred in the fuel tank 11 and the back pressure regulating valve 21. The pipe 34 may be pressurized by the back pressure regulating valve 21 at 3 atm. Since on the upstream side of the semipermeable membrane is pressurized at pressure higher than atmospheric pressure, pressure difference between the upstream side and the downstream side of the semipermeable membrane is increased and gas penetration speed is also increased.

In the fuel cell system 1b according to the first modification of the first embodiment, the semipermeable membrane installed in the CO gas removal apparatus 19b filters out substantially hydrogen in the hydrogen rich gas. Therefore, the gas with high concentration of hydrogen is introduced to the fuel electrode 5 and the efficiency of the fuel cell unit 9 may be improved.

(Second Modification of the First Embodiment)

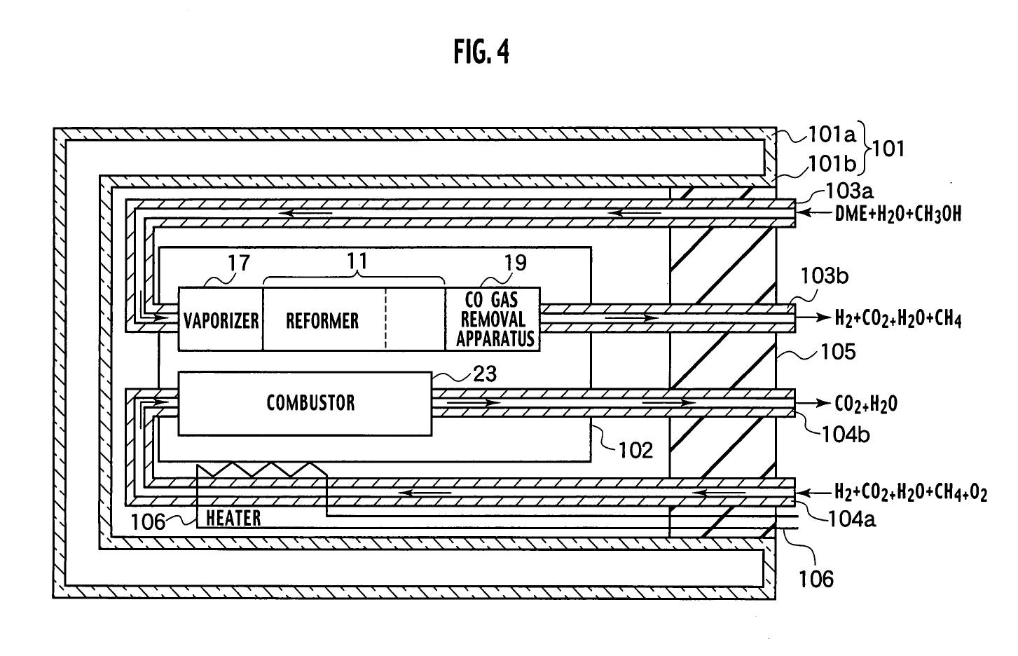

As shown in FIG. 4, a fuel cell system according to the second modification of the first embodiment includes a vacuum heatinsulationcontainer 101. In thevacuum heat insulation container 101, the vaporizer 17, the reformer 11, the CO gas removal apparatus 19 and the combustor 23 are arranged adjacent to eachother. Thevacuumheat insulation container 101 has an outer container 101a and an inner container 101b disposed and connected to the outer container 101a. The outer container 101a and the inner container 101b may be made from a glass. Pressure in the space between the outer container 101a and the inner container 101b is reduced below 10⁻³ Torr to reduce the thermal conductivity through gas. The outer container 101a and the inner container 101b can be made from stainless steel. A thin layer of silver (Ag) may be applied to the inner walls of the outer container 101a and the outer walls of the inner container 101b to decrease heat radiation.

A reforming cell 102 is provided in the inner container 101b. The vaporizer 17, the reformer 11, the CO gas removal apparatus 19 and the combustor 23 are arranged adjacent to each other in the reforming cell 102. A pipe 103a to supply the fuel (DME+H₂O+CH₃OH) from the first fuel tank 13 is coupled to the upstream side of the reformer 17. On the downstream side of the CO gas removal apparatus 19, a pipe 103b is coupled to introduce hydrogen rich gas (H₂+CO₂+H₂O+CH₄+O₂) generated in the CO gas removal apparatus 19 to the fuel electrode 5. On the upstream side of the combustor 23, apipe 104a is coupled to supply the gas including surplus hydrogen (H₂+CO₂+H₂O+CH₄+O₂). On the downstream side of the combustor 23, a pipe 104b is coupled to introduce the discharged gas (CO₂+H₂O) to the pipe 24. The pipes 103a, 103b, 104a, and 104b respectively penetrate through a thermal insulator 105 which is disposed at an opening of the vacuum heat insulation container 101. To control the temperature in the combustor 23, a heater 106 may be arranged adjacent to the combustor 23.

In the fuel cell system according to the second modification of the first embodiment, the vaporizer 17, the reformer 11, the CO gas removal apparatus 19 and the combustor 23 are disposed in the vacuum heat insulation container 101. Therefore, heat generated from the combustor 23 may not radiate to the outside and it is easy to transmit the heat from the combustor 23 to a vaporizer 17 and reformer 11 respectively. Thus, the thermal efficiency of the entire equipment is improved.

(Second Embodiment)

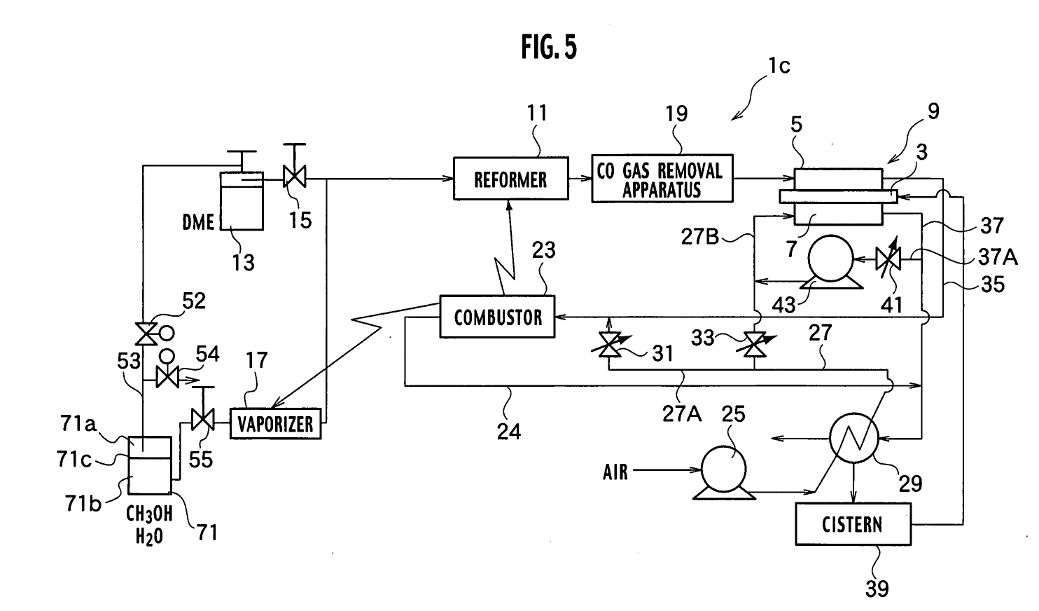

As shown in FIG. 5, in a fuel cell system 1c according to the second embodiment of the present invention includes a first fuel tank (first tank) 13 configured to store a first fuel including ether, a second fuel tank (second tank) 71 configured to store a second fuel including a methanol and a water, a vaporizer 17 configured to vaporize the second fuel, a reformer 11 configured to reform the first and second fuel into a hydrogen rich gas, a CO gas removal apparatus 19 configured to remove CO gas in the hydrogen rich gas, and a fuel cell unit 9 configured to generate electricity by allowing the hydrogen rich gas to react with oxygen.

In the first fuel tank 13, liquid DME is stored. A variable conductance valve 52 is coupled to a pipe coupled to the first fuel tank 13. A pipe 53 is coupled to the downstream side of the variable conductance valve 52. The second fuel tank 71 is coupled to the pipe 53. The pipe 53 has a branched pipe and the branched pipe is connected to a variable conductance valve 54 which is freely released to the atmosphere. When the variable conductance valve 52 is opened and the variable conductance valve 54 is closed, gas in the pipe 53 is pushed by the pressure occurs in the first fuel tank 13. In the second fuel tank 71 is separated into a first chamber 71a and a second chamber 71b, for example, by use of a movable partition 71c such as a piston or a diaphragm. A gas is provided in the first chamber 71a, and the second fuel includes methanol and water is contained in the second chamber 71b.

When gas is supplied from the pipe 53 to the first chamber 71a, the partition 71c is pressurized in the first chamber 71a and pushed to the second chamber 71b. When a variable conductance valve 55 coupled to the second chamber 71b, the second fuel in the second chamber 71b is introduced to the vaporizer 17. As for the second fuel in the second chamber 71b, ethanol and water may be used.

The vaporizer vaporized the second fuel. Detailed structures of the vaporizer 17 as shown in FIG. 5 are the same as those of the vaporizer as shown in FIG. 1, and thus, description thereof will be omitted. The second fuel vaporized in the vaporizer 17 is introduced to the reformer 11 via a pipe. At that time, DME in the first fuel tank 13 is introduced to the reformer by opening the first fuel tank 15. Points other than the above are substantially the same as those of the fuel cell system 1 shown in FIG. 1.

In the fuel cell system 1c according to the second embodiment of the present invention, the second fuel (CH₃OH+H₂O) in the second fuel tank 71 is actively supplied to the vaporizer 17 and the reformer 11 by the vapor pressure occurring in the first fuel tank 13. Therefore, a pump to supply fuel can be omitted and power that would be required for a pump is not necessary. In addition, the entire fuel cell system 1c can be miniaturized and simplified.

Moreover, in the fuel cell system 1c shown in FIG. 5, DME as the first fuel, and methanol and water as the second fuel are introduced to the reformer 11 at the same time. Therefore, in the reformer 11, reforming reaction and shifting reaction proceedsatthesametime. Sincereforming reaction of methanol can prompts reforming reaction of DME respectively, the efficiency of reforming DME into hydrogen rich gas will be improved.

In addition, methanol makes ether dissolve with water at a mole ratio of about 1:4. Therefore, the desirable mole ratio for reforming fuel into hydrogen rich gas can be obtained. Consequently, the efficiency of generating electricity in the fuel cell system 1c will be improved.

Next, with reference to FIG. 5, description will be given of a method for using the fuel cell system 1c according to the second embodiment of the present invention.

First, the variable conductance valve 15, 52, 54 and 55 are closed, and the variable conductance valve 52 is opened. The vapor pressure higher than atmospheric pressure is occurring in the first fuel tank 13. Therefore, when the variable conductance valve 52 is opened, gas in the pipe 53 is introduced to the first chamber 71a. Then, the partition 71c of the water tank 71 is pressurized and pushed from first chamber 71a side to the second chamber 71b side. When the variable conductance valve 55 is opened, the second fuel in the second chamber 71b is introduced to the vaporizer 17 by the saturated pressure occuring in the first fuel tank 13.

Next, in the vaporizer 17, the second fuel (including CH₃OH and H₂O) is vaporized. Subsequently, the vaporized fuel is introduced to the reformer 11. The variable conductance valve 15 is opened, the first fuel in the fuel tank 13 is fed to the reformer 11 while controlling the conductance, and the first fuel is mixed with the vaporized second fuel. In this event, a mixture ratio of DME as the first fuel to the water is controlled to be a mole ratio in a range of 1:3 to 1:4. Points other than the above are substantially the same as those of the fuel cell system 1 shown in FIG. 1.

(Modification of the Second Embodiment)

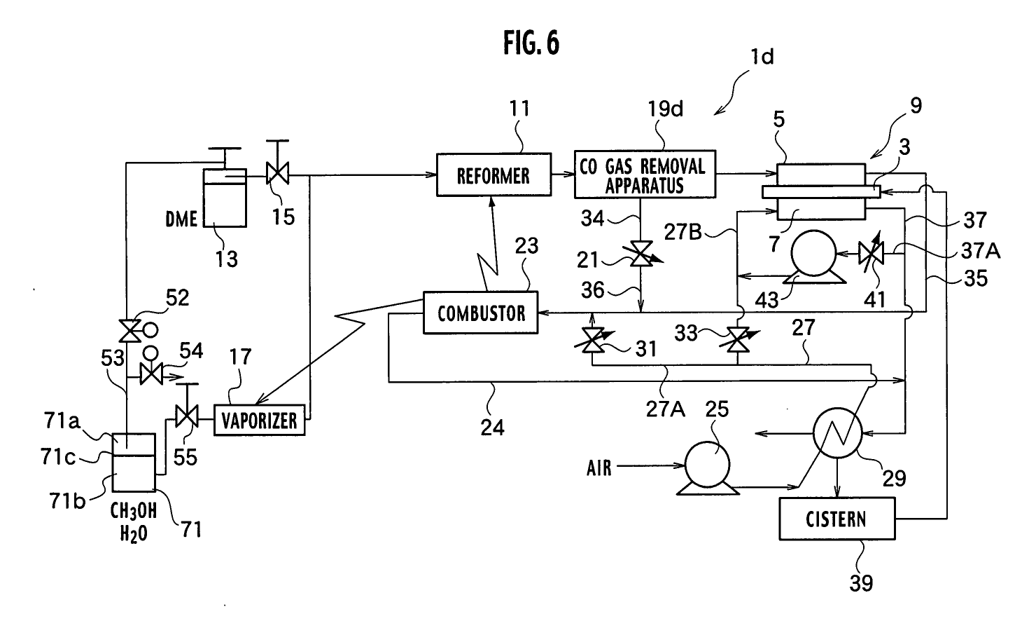

As shown in FIG. 6, in a fuel cell system 1d according to the modification of the second embodiment includes a pipe 34 coupled to the downstream side of a CO gas removal apparatus 19d, back pressure regulating valve 21 coupled to the downstream side of the pipe 34, and a pipe 36 coupled to the down stream side of the back pressure regulating valve 21. The downstream side of the pipe 36 is coupled to the pipe 35. Points other than the above are substantially the same as those of the constitution shown in FIG. 3, and thus, description will be omitted. The semipermeable membrane, which selectively filters out substantially only hydrogen, is located inside of the CO gas removal apparatus 19d as shown in FIG. 3.

In the fuel cell system 1d according to the first modification of the first embodiment, the semipermeable membrane installed in the CO gas removal apparatus 19d filters out substantially hydrogen to the fuel cell unit 9 by filtering. Therefore, the gas with high concentration of hydrogen is introduced to the fuel electrode 5 and the efficiency of the fuel cell unit 9 may be improved.

(Third Embodiment)

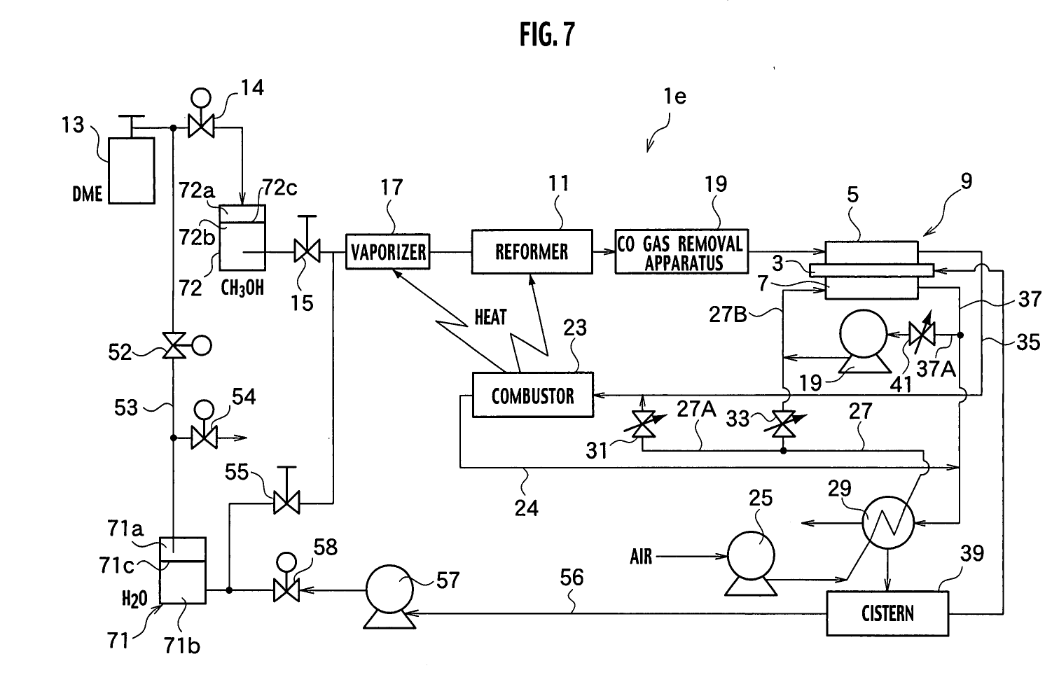

As shown in FIG. 7, in a fuel cell system le according to the third embodiment of the present invention includes a first fuel tank (first tank) 13 configured to store a fuel including DME, a second fuel tank (second tank) 71 configured to store water, a third fuel tank (third tank) 72 configured to store a methanol, a vaporizer 17 configured to vaporize water and methanol, a reformer 11 configured to introduce the water and methanol to reform into a hydrogen rich gas, a CO gas removal apparatus 19 configured to remove CO gas in the hydrogen rich gas, and a fuel cell unit 9 configured to generate electricity by allowing the hydrogen rich gas to react with oxygen.

A variable conductance valve 14 is coupled to the downstream side of the first fuel tank 13. When the variable conductance valve 14 is opened, the gas is introduced to the third fuel tank 72 via a pipe. In the third fuel tank 72 is separated into a first chamber 72a and a second chamber 72b by the partition 73c. A gas is provided in the first chamber 72a, and methanol is contained in the second chamber 72b. When gas is supplied from the pipe to the first chamber 72a, the partition 72c is pressurized in the first chamber 72a and pushed to the second chamber 72b. When the variable conductance valve 15 coupled to the downstream side of the third fuel tank 72, methanol stored in the second chamber 72b is introduced to the vaporizer 17. In the third fuel tank 72, ethanol may be stored instead of methanol.

The variable conductance valve 52 is coupled to a pipe coupled to the first fuel tank 13. The pipe 53 is coupled to the downstream side of the variable conductance valve 52. The second fuel tank 71 is coupled to the pipe 53. The pipe 53 has a branched pipe and the branched pipe is connected to a variable conductance valve 54 which is freely released to the atmosphere. When the variable conductance valve 52 is opened and the variable conductance valve 54 is closed, gas in the pipe 53 is pushed by the pressure occur in the first fuel tank 13. In the second fuel tank 71 is separated into a first chamber 71a and a second chamber 71a by use of a movable partition 71c. A gas is provided in the first chamber 71a, and water is contained in the second chamber 71b.

When gas is supplied from the pipe 53 to the first chamber 71a, the partition 71c is pressurized in the first chamber 71a and pushed to the second chamber 71b. When a variable conductance valve 55 coupled to the second chamber 71b, the second fuel in the second chamber 71b is introduced to the vaporizer 17. A pipe coupled to another downstream side of the second chamber 71b is coupled to the variable conductance valve 58. The variable conductance valve is coupled to the pump 57. The pump 57 is coupled to the cistern 39 via a pipe 56. Points other than the above are substantially the same as those of the fuel cell system 1 shown in FIG. 1.

In the fuel cell system 1e according to the third embodiment of the present invention, methanol and water is actively supplied to the vaporizer 17 and the reformer 11 by the vapor pressure occurring in the first fuel tank 13. Therefore, a pump to supply fuel can be omitted and power that would be required for a pump is not necessary and the entire fuel cell system 1e can be miniaturized and simplified.

Moreover, in the fuel cell system 1e shown in FIG. 7, when mixed gas including water and methanol is introduced to the reformer 11, reforming reaction of methanol and shifting reaction of water occurs at the same time. Since shifting reaction of water can prompts reforming reaction of methanol, the efficiency of producing hydrogen rich gas will be improved and the fuel cell system 1e can be minimized as compared to a system where the reactions are performed separately.

Here, reforming reaction of methanol and water is performed by the following equation as a whole:

CH₃OH+H₂O→3H₂+CO₂ (7)

As shown in equation (7), stoichiometric ratio of methanol and water is about 1:1. As the fuel to supply to the reformer 11, methanol and water is mixed at a mole ratio of about 1:1 to 1:2. Since only the amount of water required for reforming reaction of the methanol is evaporated in the reformer 11, evaporation heat will be saved, gas residence time in the reformer 11 will be prolonged, and reforming efficiency of the fuel cell system 1a is improved. Since the heating area of the vaporizer 17 is minimized, the entire size of the vaporizer 17 can be minimized.

Furthermore, and water stored in the cistern 39 may be used for moisturizing the polymer film 3. The moisture retention property of the polymer film 3 can be maintained in a suitable condition.

Next, with reference to FIG. 7, description will be given of a method for using the fuel cell system 1e according to the third embodiment of the present invention.

First, the variable conductance valves 15 and 52 are closed, and the variable conductance valve 14 is opened. The vapor pressure higher than atmospheric pressure acting in the first fuel tank 13 pushes the first chamber 72a. The partition 72c is pushed to the second chamber 72b side. Then, the variable conductance valve 14 is closed. Next, the variable conductance valves 54, 55 and 58 are closed, the variable conductance valve 52 is opened. When the variable conductance valve 52 is opened, gas in the pipe 53 is pushed to the first chamber 71a by the pressure occurring in the first fuel tank 13. Then, the partition 71c of the water tank 71 is pressurized and pushed from first chamber 71a side to the second chamber 71b side. When the variable conductance valve 55 is opened, water in the second chamber 71b is introduced to the vaporizer 17 by the pressure acting in the first fuel tank 13. Next, water is vaporized in the vaporizer 17 and introduced to the reformer 11.

Next, the variable conductance valve 15 is opened, methanol in the third fuel tank 72 is fed to the reformer 11 while controlling the conductance. In this event, a mixture ratio of methanol to the water is controlled to be a mole ratio of 1:1 to 1:2. When the variable conductance valve 52, 55, and 58 are closed and the variable conductance valve 54 is opened, the pressure occurring in the first chamber 71a is released and water in the cistern 39 is fed to the second chamber 71b at the atmospheric pressure by the pump 57. When the variable conductance valve 58 is opened, water can be supplied to the second chamber 71b by pressurizing water in a state of static water pressure by the pump 57. Then, the pump 57 is stopped and the variable conductance valve 58 is closed. Points other than the above are substantially the same as those of the fuel cell system 1 shown in FIG. 1.

(First Modification of the Third Embodiment)

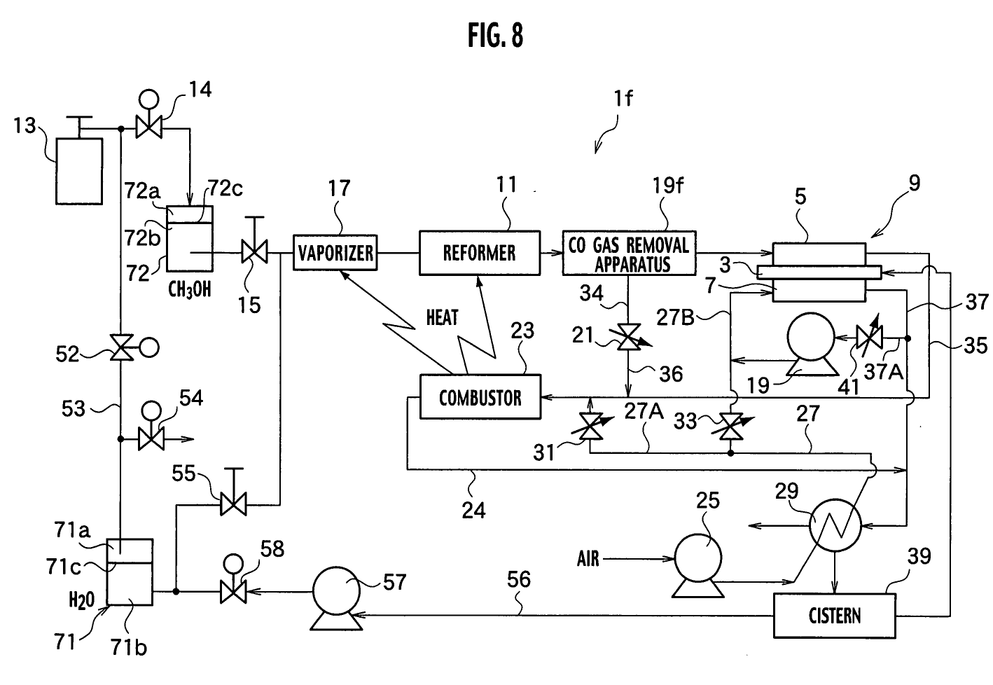

As shown in FIG. 8, in a fuel cell system lf according to the first modification of the third embodiment includes a pipe 34 coupled to the downstream side of a CO gas removal apparatus 19f, a back pressure regulating valve 21 coupled to the downstream side of the pipe 34, and a pipe 36 coupled to the down stream side of the back pressure regulating valve 21. The downstream side of the pipe 36 is coupled to the pipe 35. Points other than the above are substantially the same as those of the constitution shown in FIGS. 3 and 5, and thus, description will be omitted. The semipermeable membrane, which selectively filters out substantially hydrogen, is located inside of the CO gas removal apparatus 19f as shown in FIG. 8.

In the fuel cell system lf according to the first modification of the first embodiment, the semipermeable membrane installed in the CO gas removal apparatus 19f filters out substantially hydrogen to the fuel cell unit 9 by filtering. Therefore, the gas with high concentration of hydrogen is introduced to the fuel electrode 5 and the efficiency of the fuel cell unit 9 may be improved.

(Second Modification of the Third Embodiment)

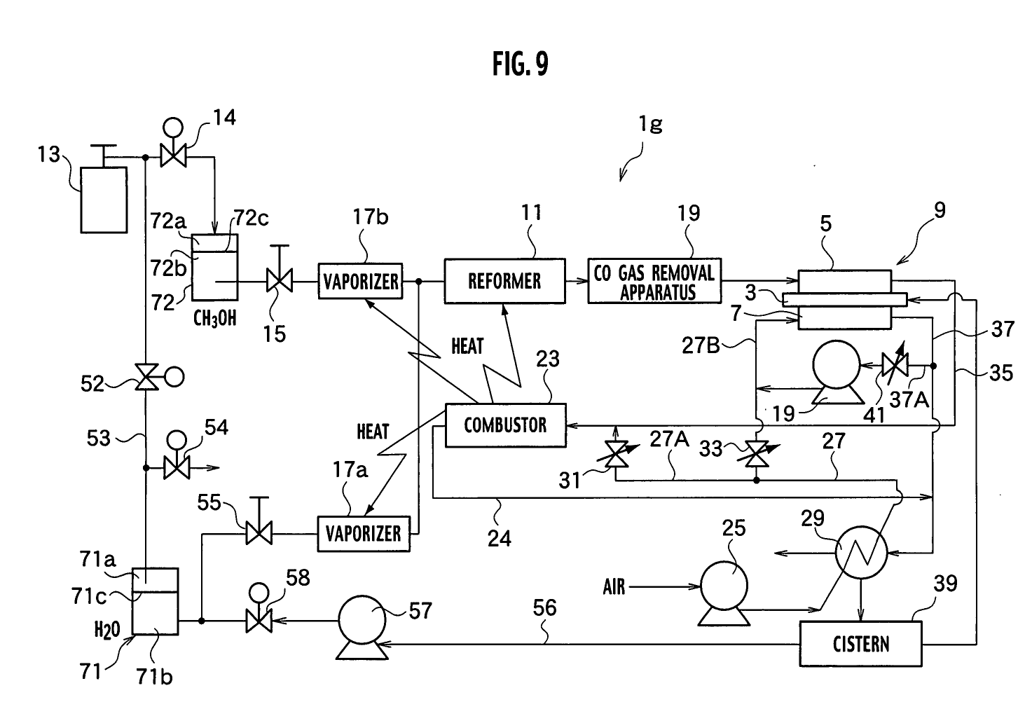

As shown in FIG. 9, in a fuel cell system 1g according to the second modification of the second embodiment includes a first vaporizer 17a coupled to the downstream side of the second fuel tank 71 via the variable conductance valve 55 and a second vaporizer 17b coupled to the downstream side of the third fuel tank 72 via the variable conductance valve 15. In the fuel cell system 1g as shown in FIG. 9, water in the second fuel tank 71 is vaporized in the first vaporizer 17a and methanol in the third fuel tank 72 is vaporized in the second vaporizer 17b by the saturated vapor pressure occurfing in the first fuel tank 3. Therefore, a pump to supply fuel and water can be omitted and the entire fuel cell system 1g can be miniaturized and simplified.

(Third Modification of the Third Embodiment)

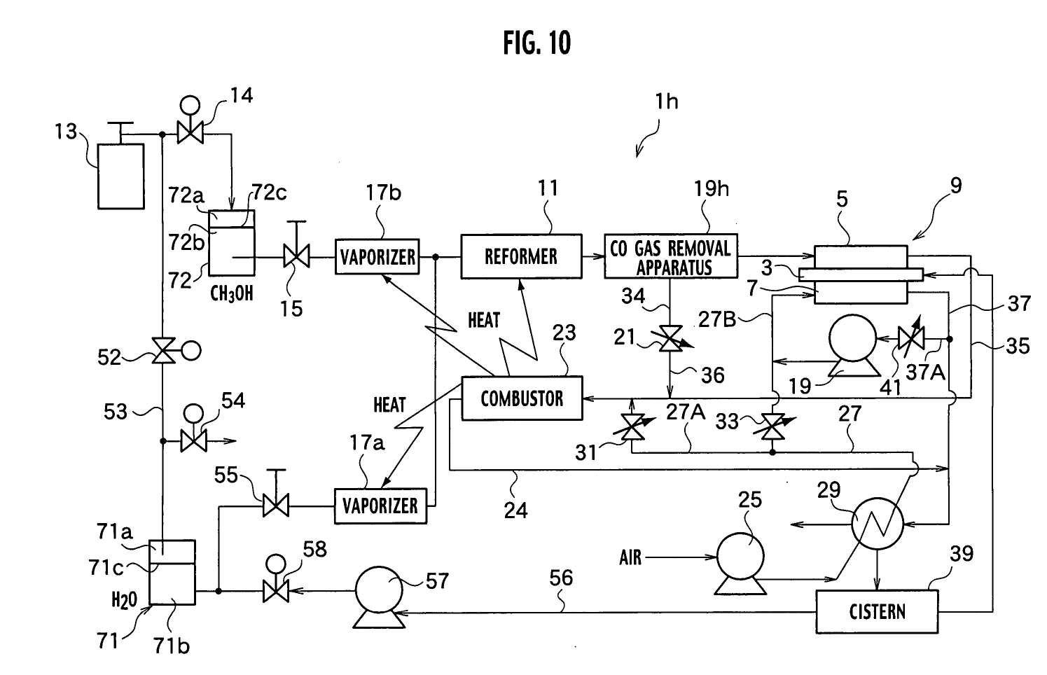

As shown in FIG. 10, in a fuel cell system 1h according to the third modification of the third embodiment includes a first vaporizer 17a coupled to the downstream side of the second fuel tank 71 via the variable conductance valve 55 and a second vaporizer 17b coupled to the downstream side of the third fuel tank 72 via the variable conductance valve 15. A pipe 34 coupled to the downstream side of a CO gas removal apparatus 19h, back pressure regulating valve 21 coupled to the downstream side of the pipe 34, and a pipe 36 coupled to the down stream side of the back pressure regulating valve 21. The downstream side of the pipe 36 is coupled to the pipe 35.

In the fuel cell system 1h according to the first modification of the first embodiment, the semipermeable membrane installed in the CO gas removal apparatus 19h filters out substantially hydrogen to the fuel cell unit 9 by filtering. Therefore, the gas with high concentration of hydrogen is introduced to the fuel electrode 5 and the efficiency of the fuel cell unit 9 may be improved.

(Fourth Embodiment)

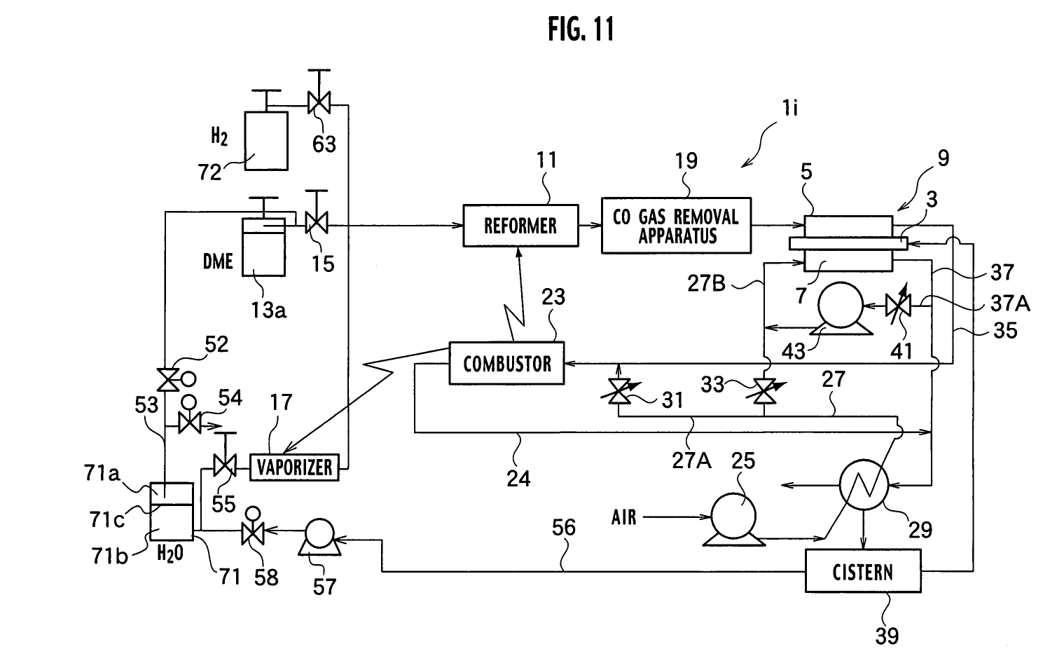

As shown in FIG. 11, in a fuel cell system 1i according to the fourth embodiment of the present invention includes a first fuel tank (first tank) 13 configured to store a fuel including ether, a second fuel tank (second tank) 71 configured to store a water for reforming the fuel, a third fuel tank (third tank) 72 configured to store a hydrogen, a vaporizer 17 configured to vaporize the water, a reformer 11 configured to introduce the fuel, water, and hydrogen to reform the fuel into a hydrogen rich gas, a CO gas removal apparatus 19 configured to remove CO gas in the hydrogen rich gas, and a fuel cell unit 9 configured to generate electricity by allowing the hydrogen rich gas to react with oxygen.

The variable conductance valve 52 is coupled to a pipe coupled to the first fuel tank 13. The pipe 53 is coupled to the downstream side of the variable conductance valve 52. The second fuel tank 71 is coupled to the pipe 53. The pipe 53 has a branched pipe and the branched pipe is connected to a variable conductance valve 54 which is freely released to the atmosphere. When the variable conductance valve 52 is opened and the variable conductance valve 54 is closed, gas in the pipe 53 is pushed by the pressure occurring in the first fuel tank 13. In the second fuel tank 71 is separated into a first chamber 71a and a second chamber 71b, by use of a movable partition 71c. Gas is filled in the first chamber 71a, and the water is filled in the second chamber 71b. When gas is supplied from the pipe 53 to the first chamber 71a, the partition 71c is pressurized in the first chamber 71a and pushed to the second chamber 71b. When, a variable conductance valve 55 coupled to the second chamber 71b, the second fuel in the second chamber 71b is introduced to the vaporizer 17.

On the downstream side of the first fuel tank 13, the third fuel tank 72 is coupled via the pipe having the variable conductance valve 63. The third fuel tank 72 is also coupled to the upstream side of the reformer 11. A pipe coupled to the downstream side of the third fuel tank 72 is coupled to the variable conductance valve 63.

When the variable conductance valve 63 is opened while adjusting flow rate, hydrogen in the third fuel tank 72 is fed to the reformer 11 while controlling the conductance. In this event, 8-20 wt %, more desirable to 8-12 wt % of the hydrogen gas may be agreeable to supply to the mixture of DME and water at a mole ratio range of 1:3 to 1:4. In the reformer 11, reforming reaction of DME and water shown in equation (2) and (3) and shifting reaction shown in equation (4) is improved by use of the reforming catalyst and the shift catalyst.

Hydrogen in the third fuel tank 72 is supplied to the reformer 11 with DME and water. Hydrogen makes the reforming reaction of DME faster as shown in equation (2). Therefore, the efficiency of the reforming DME into hydrogen rich gas will be improved. Points other than above is the same of those of the fuel cell system 1a shown in FIG. 1, detailed explanation is omitted.

In the fuel cell system 1i according to the fourth embodiment of the present invention, hydrogen in the third fuel tank 72 is supplied to the reformer 11 and mixed with DME and water supplied from the first fuel tank 13 and second fuel tank 71 respectively. In the reformer 11, reforming reaction of DME and shift reaction may be performed at the same time by use of the reforming catalyst and the shift catalyst. In other words, when the shift reaction (4) occurs, CO is reacted and removed. When concentration of CO is decreasedinthereformerll, reaction (3) occursandmethanol is decomposed. When methanol is decreased in the reformer 11, reaction (1) proceeds and DME is reformed. As a result, reforming reaction of DME proceeds effectively. Therefore, the fuel cell system 1i as shown in FIG. 11 can achieve high efficiency of reforming fuels into hydrogen rich gas. Further, since the removing catalyst and shift catalyst are provided in the same container, it is possible to minimize the size of the fuel cell system 1i.

Next, with reference to FIG. 11, description will be given of a method for using the fuel cell system 1i according to the fourth embodiment of the present invention.

First, the variable conductance valve 15, 54, 55 and 58 are closed, and the variable conductance valve 52 is opened. The vapor pressure higher than atmospheric pressure is occurring in the first fuel tank 13. Therefore, when the variable conductance valve 52 is opened, gas in the pipe 53 is introduced to the first chamber 71a. Then, the partition 71c of the water tank 71 is pressurized and pushed from first chamber 71a side to the second chamber 71b side. When the variable conductance valve 55 is opened, water in the second chamber 71b is introduced to the vaporizer 17 by the saturated pressure occurring in the first fuel tank 13.

Next, in the vaporizer 17, water is vaporized. Subsequently, the vaporized fuel is introduced to the reformer 11. The variable conductance valve 15 is opened, the first fuel in the fuel tank 13 is fed to the reformer 11 while controlling the flow rate, and the first fuel is mixed with the vaporized second fuel. In this event, a mixture ratio of DME as the first fuel to the water is controlled to be a mole ratio range of 1:3 to 1:4. Then, the variable conductance valve 63 is opened and hydrogen in the third fuel tank 72 is supplied to the reformer 11. Points other than the above are substantially the same as those of the fuel cell system 1 shown in FIG. 1.

(Modification of the Fourth Embodiment)

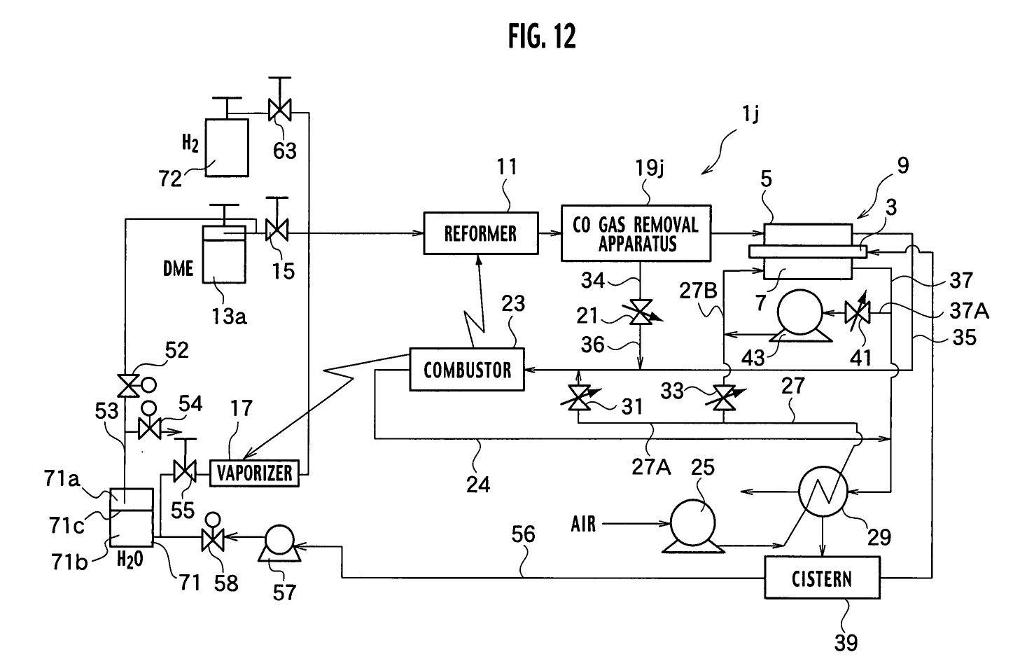

As shown in FIG. 12, in a fuel cell system lj according to the modification of the fourth embodiment includes a pipe 34 coupled to the downstream side of a CO gas removal apparatus 19j, a back pressure regulating valve 21 coupled to the downstream side of the pipe 34, and a pipe 36 coupled to the down stream side of the back pressure regulating valve 21. The downstream side of the pipe 36 is coupled to the pipe 35. Points other than the above are substantially the same as those of the constitution shown in FIG. 3, and thus, description will be omitted.

In the fuel cell system lj according to the modification of the fourth embodiment, the semipermeable membrane installed in the CO gas removal apparatus 19j filters out substantially hydrogen to the fuel cell unit 9 by filtering. Therefore, the gas with high concentration of hydrogen is introduced to the fuel electrode 5 and the efficiency of the fuel cell unit 9 may be improved.

Various modifications will become possible for those skilled in the art after receiving the teachings of the present disclosure without departing form the scope thereof.

What is claimed is:

1. A fuel cell system comprising:
a fuel tank storing a fuel comprising an ether, water, and an alcohol;
a vaporizer vaporizing the fuel;
a reformer reforming the vaporized fuel into a hydrogen rich gas;
a CO gas removal apparatus configured to remove CO gas in the hydrogen rich gas; and
a fuel cell unit configured to generate electricity by electrochemical reaction of the hydrogen rich gas and oxygen.

2. The fuel cell system of claim 1, wherein the fuel includes a dimethyl ether.

3. The fuel cell system of claim 1, wherein the fuel includes a methanol.

4. The fuel cell system of claim 1, wherein the fuel includes an ethanol.

5. The fuel cell system of claim 1, wherein the fuel includes less than 10 wt % of methanol.

6. The fuel cell system of claim 1, wherein the fuel includes:
dimethyl ether;
water; and
5-10 wt % of methanol,
wherein the mixing ratio of dimethyl ether and water is in a range of 1:3 to 1:4.

7. The fuel cell system of claim 1, wherein the fuel tank comprises:
a cartridge unit configured to store a fuel;
a valve unit configured to close an opening of the cartridge unit;
a holding unit facing to the opening and configured to hold the cartridge unit; and
a supplying unit connected to the holding unit and configured to supply the fuel.

8. The fuel cell system of claim 7, wherein the cartridge unit stores a dimethyl ether.

9. The fuel cell system of claim 1, further comprising:
a combustor combusting a gas supplied from the fuel cell unit; and
a vacuum heat insulation container containing the combustor, containing the vaporizer, the reformer, and the CO gas removal apparatus disposed adjacent to the combustor.

10. The fuel cell system of claim 1, wherein the reformer contains a reforming catalyst of an alumina and at least one material selected from the group consisting of Rh, Pd, Pt, and Cu.

11. The fuel cell system of claim 1, wherein the reformer contains a reforming catalyst to prompt a reforming reaction of the fuel and a shift catalyst to react carbon monoxide generated by the reforming reaction with water.

12. A fuel cell system comprising:
a first fuel tank storing a first fuel including ether;
a second fuel tank storing a second fuel including a methanol and water;
a vaporizer vaporizing the second fuel;
a reformer reforming the first and second fuel into a hydrogen rich gas;
a CO gas removal apparatus configured to remove CO gas from the hydrogen rich gas; and
a fuel cell unit configured to generate electricity by electrochemical reaction of the hydrogen rich gas and oxygen.

13. The fuel cell system of claim 12, wherein the first fuel includes a dimethyl ether.

14. The fuel cell system of claim 12, wherein the first fuel includes dimethyl ether and the second fuel includes 5-10 wt % of methanol, and the mixing ratio of dimethyl ether and water is in a range of 1:3 to 1:4.

15. The fuel cell system of claim 12, wherein the first fuel tank comprises:
a cartridge unit configured to store a fuel;
a valve unit configured to close an opening of the cartridge unit;
a holding unit facing to the opening and configured to hold the cartridge unit; and
a supplying unit connected to the holding unit and configured to supply the fuel.

16. The fuel cell system of claim 12, wherein the reformer contains a reforming catalyst of alumina and at least one material selected from the group consisting of Rh, Pd, Pt, and Cu.

17. The fuel cell system of claim 12, wherein the reformer contains a reforming catalyst to prompt a reforming reaction of the fuel and a shift catalyst to react carbon monoxide generated by the reforming reaction with water.

18. A fuel cell system comprising:
a first tank storing a fuel including ether;
a second tank storing water;
a third tank storing a hydrogen;
a vaporizer vaporizing the water;
a reformer reforming the fuel, water, and hydrogen into a hydrogen rich gas;
a CO gas removal apparatus configured to remove CO gas from the hydrogen rich gas; and
a fuel cell unit configured to generate electricity by electrochemical reaction of the hydrogen rich gas and oxygen.

19. The fuel cell system of claim 18, wherein the first tank comprises:
a cartridge unit configured to store the fuel;
a valve unit configured to close an opening of the cartridge unit;
a holding unit facing to the opening and configured to hold the cartridge unit; and
a supplying unit connected to the holding unit and configured to supply the fuel.

20. The fuel cell system of claim 18, wherein the reformer contains a reforming catalyst of alumina and at least one material selected from the group consisting of Rh, Pd, Pt, and Cu.

21. The fuel cell system of claim 18, wherein the reformer contains a reforming catalyst to prompt a reforming reaction of the fuel and a shift catalyst to react carbon monoxide generated by the reforming reaction with water.

22. A fuel for a fuel cell system comprising:
dimethyl ether;
water; and
5-10 wt % of methanol,
wherein the mixing ratio of dimethyl ether and water is in a range of 1:3 to 1:4.

23. A fuel tank for a fuel cell system comprising:
dimethyl ether;
water; and
methanol.
